(19) United States
(12) Patent Application Publication
(10) Pub. No.: US 2015/0315518 A1
(43) Pub. Date: Nov. 5, 2015

(54) COLD WATER DETERGENT COMPOSITION AND METHOD

(71) Applicants: John E. Walls, Kentwood, MI (US); Ruth Smith, Traverse City, MI (US)

(72) Inventors: John E. Walls, Kentwood, MI (US); Ruth Smith, Traverse City, MI (US)

(21) Appl. No.: 14/266,011

(22) Filed: Apr. 30, 2014

(51) Int. Cl. C11D 1/94; C11D 3/10; C11D 3/39

(52) U.S. Cl. CPC C11D 1/94; C11D 3/3942; C11D 3/10

(57) ABSTRACT

A cold water cleaning composition containing a peroxy compound, a chelating agent, a silicate, an acrylic polymer, an anionic surfactant, an amphoteric surfactant and an ionic surfactant in a basic composition using a water soluble metal hydroxide and a water soluble metal carbonate is provided. The base for the detergent is a water soluble metal alkali such as sodium, potassium or lithium hydroxide, and a metal carbonate such as sodium, potassium or lithium carbonate.

### FIELD OF THE INVENTION

The present invention relates to an improved composition for washing laundry. It is advantageously used in cold water. It may further be used as a liquid for automatically adding to a washing unit, or may be used as a powder for top loading. The invention is primarily directed to industrial or commercial applications where heavy duty cleaning is essential, although the invention finds use in home applications or light duty washing.

### BACKGROUND OF THE INVENTION

Heavy duty liquid and powder detergent compositions for industry and commercial use generally are well known and are perceived as performing suitably in most applications. For acceptable performance, the use of hot water is not only advantageous, but typically essential. For hospitals, health care facilities, hotels, restaurants and the like, a guideline is that washing must be performed at a temperature of at least 70° C. (160° F.). In certain instances the temperatures may be lowered, but hot water is essential for effective cleaning and disinfecting. The present invention is found to perform acceptably at temperatures in the range of about 4° to about 20° C. (about 40° to about 68° F.), hereinafter referred to as “cold” temperature as well as higher temperatures.

Commercial and industrial facilities, such as hotels, hospitals and the like, consume remarkably high levels of energy for washing of fabrics such as bedding, towels, etc. Additionally, given the chemicals used for effective cleaning of fabrics, large volumes of water are used to rinse and remove most of the cleaning additives and render the fabric surfaces non-irritating to skin.

With the increasing trend to cold water washing of fabrics at wash water temperatures below about 20° C. for energy conservation, improved commercial laundry detergent compositions are desired that reduce reclaim and thus the need for rewashing of fabrics.

### SUMMARY OF THE INVENTION

An improved cold water detergent cleaning composition containing an inorganic hydroxide, a metal carbonate, a peroxy compound, a chelating agent, a meta- or orthosilicate, an acrylic polymer, an anionic surfactant, an amphoteric surfactant and a nonionic surfactant is disclosed. The composition is useful for laundry use at “cold” temperatures, i.e. normally considered to range from about 4 to about 20° C. (about 40 to about 68° F.).

An embodiment comprises a particulate precursor laundry detergent composition which is substantially free of water and which is substantially completely soluble in alkaline cold water to form a cleaning solution for fabrics said composition comprising: (a) about 2 to about 20 weight percent of an inorganic hydroxide compound; (b) about 1 to about 20 weight percent of metal carbonate; (c) about 1 to about 20 weight percent of a peroxy compound; (d) about 0.1 to about 7 weight percent of a chelating agent; (e) about 0.1 to about 7 weight percent of a metasilicate, orthosilicate or mixture thereof; (f) about 0.05 to about 7 weight percent of an acrylic polymer; (g) about 0.1 to about 10 weight percent of an anionic surfactant; (h) about 0.1 to about 12 weight percent of a nonionic surfactant; and, (i) about 0.1 to about 10 weight percent of an amphoteric surfactant.

The forgoing composition may be dissolved in water to form a liquid detergent, or blended together in dry form substantially free of water to make a powder detergent. As a powder it is referred to as a stain pack and is used to remove stains and marks otherwise difficult to remove through conventional washing. The liquid detergent is especially useful for industrial laundry facilities that have automatic systems for adding laundry detergents and other materials to the wash water. When mixed with water the liquid detergent contains about 40 to about 60% water with the remainder being dissolved therein the constituents of the particulate detergent.

Optionally when the precursor detergent is in particulate form the composition may include a bleaching agent such as hypochlorite, hypochlorate, or a chlorocyanurate. When using the detergent as a liquid, the bleaching agent is not part of the liquid detergent but is added during the wash cycle when the liquid detergent is added. The bleaching agent is used an amount ranging from about 0.1 to about 2.0 weight percent in the dry particulate detergent, preferably in an amount ranging from about 0.02 to about 0.5 weight percent.

After the wash cycle, the fabrics are rinsed and the rinse water is highly alkaline. This is not preferred since the fabrics may result in contact dermatitis when in contact with the skin for extended periods of time. Also, the fibers of the fabrics tend to make the feel of the washed goods seem abrasive and not smooth. As an additional step in the method of washing disclosed herein, a third step, an acid is added to the second rinse water before the final rinse cycle to reduce the pH to less than about 7, preferably from about 6 to about 7.5. Typically, acetic acid or citric acid can be used for example. In the process of the present invention, citric acid is preferred. It does not result in an after odor; it effectively neutralizes the residual alkalinity, and provides a washed product that is superior in terms of appearance and feel.

The composition and method of the invention reduces the amount of reclaim (reclaim is the portion of fabrics that upon inspection are rewashed because they have not be adequately cleaned during a laundry process). It also permits the use of cold water thus reducing energy usage and improves economics. Unless otherwise noted, all percentages (%) used herein are on a weight basis.

### DETAILED DESCRIPTION OF THE INVENTION

The main components of the precursor detergent comprise a water soluble inorganic hydroxide, as metal alkali such as sodium, potassium or lithium hydroxide or ammonium hydroxide or mixtures thereof, and a metal carbonate such as sodium, potassium, lithium, rubidium, caesium carbonate or mixtures thereof.

Optionally when the precursor detergent is in particulate form the composition may also include about 0.1 to about 2.0 weight percent, preferably 0.02 to about 0.5 weight percent, of a bleaching agent such as hypochlorite, hypochlorate, or a chlorocyanurate. Examples of bleaching agents include sodium hypochlorite, calcium hypochlorite and or sodium dichloroisocyanurate and mixtures thereof. Due to the economics, sodium hypochlorite is generally preferred over calcium hypochlorite. Either will tend to lighten or fade colored fabrics. In combination with the above described composition, it has been surprisingly found that the use of sodium dichloroisocyanurate in combination with the detergent results in more effective cleaning and stain removal than a hypochlorite bleach. Further, it does not adversely impact on colored material. In the case of the liquid detergent, the sodium dichloroisocyanurate should be separately added to the wash cycle and not to the liquid detergent. It is preferred to not use the dichloroisocyanurate in the liquid detergent because it tends to breakdown components of the detergent, thus reducing the effectiveness of the detergent. In the case of the solid form of the detergent (stain pack), the sodium dichloroisocyanurate, being a solid material, is added to the entire particulate composition. As previously stated a bleach is added as part of the stain pack or separately at the point of use when the detergent is in liquid form added as a liquid to the wash cycle.

The peroxy compound includes, but is not restricted to a monovalent salt of perborate, percarbonate, peroxymonosulfate, peroxydisulfate, perchlorate, peroxy acid, perchloric acid, lithium peroxide, sodium peroxide, benzoyl peroxide, and hydrogen peroxide and mixtures thereof. Peroxides are known to have reduced shelf life especially in aqueous systems. To improve the storage capability an additive such as, but limited to phosphonate salts, dialkyl anilines, carbazole sulfonates, diarylamine sulfonates and the like can be used in the composition.

A suitable chelating agent includes, but is not limited to ethylenediamine tetraacetic acid (mono-, di-, tri- and tetra salts), nitrilotriacetic acid, ligno sulfonates, hunic acid, fulvic acid, citric acid, and various amino acids.

The metasilcate, orthosilicate or mixture thereof may be a sodium, potassium or lithium silicate wherein the metal oxide to silicon dioxide ratio (M2O:SiO2) may be from about 1.0:1.6 to about 1.0:3.25.

The acrylic polymer may be an acrylic, methacrylic, ethacrylate, butacrylate copolymer or homopolymer, and the various esters formed with the pendant carboxylic acid group. In the case of a copolymer, the copolymerizing component may be maleic acid, maleic anhydride, fumaric acid, vinyl acetate, cyanoacrylate, acetonitrile, and the like.

The anionic surfactant is preferably an alkyl naphthalene sulfonate, alkylbenzene sulfonate, or a bis alkylaryl ether sulfonate. It is preferably a salt of sulfonic acid rather than the free acid. Examples include but are not restricted to dodecylbenzene sulfonic acid salt, tridecylbenzene sulfonic acid salt, t-butyl naphthalene sulfonic acid salt, diisopropylnaphthalene sulfonic acid salt, sodium dodecyldiphenylene oxide disulfonate, sodium n-hexadecyldiphenyleneoxide disulfonate, and the like. Preferred anionic surfactants are selected from the group consisting of sodium xylene sulfonate, sodium toluene sulfonate, sodium cumene sulfonate, sodium t-butyl sulfonate, sodium diisopropylnaphthalene sulfonate, sodium dodecylbenzene sulfonate, 4,4′ bis (dodecylbenzene) ether, sodium salt, sodium lauryl sulfate, sodium laureth sulfate, and mixtures thereof.

The nonionic surfactant is preferably an ethoxylated alkyl alcohol. Examples include, but are not restricted to octyl oxypolyethylene ethanol, nonyl oxypolyethylene ethanol, decyl oxypolyethylene ethanol, dodecyl oxypolyethylene ethanol, tridecyl oxypolyethylene ethanol, hexa oxypolyethylene ethanol, and the like. Also found to be useful are alkylaryl ethoxylates. Some examples are nonyl phenoxypolyoxyethlene ethanol, octyl phenoxypolyoxyethlene ethanol, and decyl phenoxypolyoxyethlene ethanol. It is to be noted that dialkyl analogs of the alkylarylethoxylates are similarly useful. Further, the propoxylated analogs of the foregoing are also found to be useful. The degree of ethoxylation or propoxylation is not as significant as the HLB value (hydrophil—lipophil balance). Generally, an HLB of less than about 10 is not particularly useful. More advantageous is when the HLB is greater than about 10 and particularly greater than about 12.

An amphoteric surfactant is also included. Amphoteric surfactants have both cationic and anionic centers attached to the same molecule. The cationic part is based on primary, secondary, or tertiary amines or quaternary ammonium cations. The anionic part can be more variable and include sulfonates, as in CHAPS (3-[(3-Cholamidopropyl)dimethylammonio]-1-propanesulfonate). Other anionic groups are sultaines illustrated by cocamidopropyl hydroxysultaine, betaines, such as cocamidopropyl betaine, and phosphates such as lecithin. Particularly useful are dialkylcarboxy—alkylether amine salts. They act as a cleaner by having both positive and negative charges. They also stabilize the total composition by facilitating compatibility between components that would otherwise be incompatible. Such incompatibility is exemplified by phasing or separation into two or more layers what should be a homogeneous system. The amphoteric surfactant is used in the range of about 0.1% to about 10%. More preferred is about 0.4% to about 8%. Most preferred is about 1% to about 6%. A preferred group of amphoteric surfactants is selected from the group consisting of laurylaminopropylamine oxide, myristalaminopropylamine oxide, comixtures thereof, disodium lauryl iminodipropionate, imidazolines and imidazoline derivatives and mixtures thereof.

Optionally other additives such as optical brighteners, fragrances, colorants, viscosity modifiers, softening agents, enzymes and quaternary surfactants may be added to the compositions. The quaternary surfactant can be used as a microcide, or microstat.

The hydroxide compound used is to create an alkaline environment for the other active chemicals. Although a hydroxide compound will introduce a level of cleaning, that is not the primary purpose. The pH of the wash water is preferably greater than about 7, but most preferably greater than about 1, more preferred is greater than about 12 and most preferred is greater than about 13. The amount used is that required to achieve the desire pH with about 10% extra to act as a buffer. The range for a hydroxide in the detergent based on the total constituents other than water is about 2% to about 20%. More preferred is about 5% to about 17% and most preferred is about 8% to about 14%. Unless otherwise noted all percentages (%) used herein are on a weight basis.

The metal carbonate is a bulking chemical but also adds significant cleaning ability for simple stains and loosely adhering dirt and particles. Although potassium tends to be better than lithium or sodium, sodium is typically used for cost purposes. The amount used is about 1% to about 20%. More preferred is about 3% to about 15%. Most preferred is about 5% to about 10% based on the other constituents of the particulate detergent.

The peroxy compound is added as an oxidizer. By contributing nascent oxygen, the cleaning power of the composition is significantly increased. Very difficult to remove stains such as blood, coffee, urine and the like are removed by the oxidizing capability of the peroxy compound. The amount used is about 1% to about 20%. More preferred is about 3% to about 15%. Most preferred is about 5% to about 10% based on the other constituents of the particulate detergent.

The chelating agent is added to complex with multivalent ions to assist in making the water less hard. Calcium in particular is prevalent in most water used for washing fabrics such as clothes. It makes the water hard. The harder the water, the more difficult it is for the detergent system to effectively clean the material being washed. It is not uncommon for water to be so hard that white material looks gray. By chelating the calcium from the solution, the quality of the wash is greatly improved. The amount of a chelating agent is from about 0.1% to about 7%. More preferred is about 0.6% to about 5%. Most preferred is from about 1% to about 3% based on the particulate constituents of the detergent. Preferred chelating agents are selected from the group consisting of ethylenediaminetetraacertic acid, ethylene diamine triacetic acid, hydroxethylenediamine triacetic acid, nitiloacetic acid, melamine, monodentate, bidentate, mono salts of the forgoing and mixtures thereof.

The metasilicate and orthosilicate contains a 1:1 ratio of metal oxide to silicon dioxide such that the formula will always be M₂SiO₃. The silicate acts as a foam stabilizer, pH former and also adds to the cleaning strength. The amount used is about 0.1% to about 7%. More preferred is about 0.5% about 5%. Most preferred is about 1% to about 4% of the particulate detergent. The silicate is preferably selected from the group consisting of sodium metasilicate, potassium metasilicate, sodium orthosilicate, potassium orthosilicate and lithium orthosilicate and mixtures thereof.

The acrylic polymer or copolymer is preferably used in a neutralized form since the natural state is rather acidic and would tend to reduce the alkalinity of the detergent. The acrylic polymer is added to primarily prevent the re-deposition of removed dirt, soil and stains. It also helps in the control of divalent metals that otherwise tend to harden the water and make cleaning more difficult. The polymer may be supplied as a liquid or solid. The polymer is again desired to have a pH of about 7.0+0.5, has a molecular weight greater than about 1000, more preferred greater than about 4000, and most preferred greater than about 6000. A molecular weight greater than about 70,000 is too high and results in other undesirable issues such as the inability to rinse the polymer from the material being cleaned. The amount added as a solid is in the range of about 0.05% to about 7%. More preferred is about 0.1% to about 5%, and most preferred is from about 0.5% to about 3% of the particulate detergent. Preferred acrylic polymers are selected from the group consisting of polyacrylic acid, polyacrylic polyvinyl acetate copolymer, poly acrylic acid polyvinyprrolidone copolymer and mixtures thereof.

The anionic surfactant by its nature adheres to dirt, soil and stains by virtue of it having a negative charge. The monovalent counter ion, usually sodium is easily displaced allowing the molecule to be attracted to a positively charge material, thereby solubilizing it and allowing for the removal. The percentage range for an anionic surfactant as a solid is about 0.1% to about 10%. More preferred is about 0.5% to about 7% and most preferred is about 1% to about 4%. A preferred group of anionic surfactants is selected from the group consisting of sodium xylene sulfonate, sodium toluene sulfonate, sodium cumene sulfonate, sodium t-butylbenzene sulfonate, sodium diisopropyinaphthalene sulfonate, sodium dodecylbenzene sulfonate, 4,4′ his (dodecylbenzene)ether, sodium salt, sodium lauryl sulfate, sodium laureth sulfate, and mixtures thereof.

The nonionic surfactant employed should have a HLB of greater than about 10.0. More preferred is greater than about 12 and most preferred in the range of about 13 to about 16. HLB values approaching the theoretical maximum of about 20 tend to foam and are less effective for cleaning. The nonionic surfactant has no charge. It reduces the surface tension of water which is on average about 72 dynes/cm² to less than about 40 dynes/cm². A range of about 30 to about 20 dynes/cm² is most preferred. The reduction in surface tension allows for better wetting and therefore penetration of all active components into the mesh of the fabric. Certain materials are more difficult to wet the surface and the nonionic surfactant through capillary action permits the entire surface to be wetted improving the cleaning of the fabric. The percentage range for a nonionic surfactant is about 0.1% to about 12%. More preferred is about 0.3% to about 8% and most preferred is about 5% to about 5% based on the other active constituents of the detergent. Since nonionic surfactants are made by ethoxylation or propoxylation, they are typically a liquid, but are available as a waxy material or solid. Liquid forms may be added to the composition when mixed with water to form the liquid detergent of the present invention. Preferred nonionic surfactant is selected from the group consisting of: alkylarylpolyoxyethylene ethanol, polyoxyethylene alcohols, polyoxyethylene/polyoxypropylene copolymers, and mixtures thereof.

One embodiment of the laundry method of the present invention comprises: (a) adding soiled fabrics to the wash water; (b) adding a precursor detergent composition of the invention to the wash water in an amount of about 0.01 to about 1.0 oz. per gallon of wash water; (c) adding a water soluble alkali basic material to the wash water in an amount to adjust the pH of the wash water to greater than about 7; (d) adding a dichloroisocyanurate to the wash water in an amount of from about 0.01 to about 1.0 oz., preferably about 0.01 to about 0.5 oz., per gallon of wash water; (e) running the wash cycle for a period of time sufficient to clean said fabrics; (f) rinsing the fabrics following the wash cycle with a first cold water rinse cycle; (g) removing the first rinse cycle water from the fabrics; (h) adding cold water to the first rinsed fabrics from step (g) for a second rinse cycle and adding a sufficient amount of an acid to form a pH in said second rinse water of less than about 7 and rinsing said fabrics, and (i) recovering the fabrics from the second rinse cycle. Almost any acid would work. Inorganic acids are not preferred due to handling issues. Mono-, di-, and polycarboxylic acids are suitable. For instance, propionic, ethanedioic, ascorbic, succinic, tartaric, are suitable. Citric acid is especially preferred.

The particulate precursor detergent of the present invention can be prepared by blending the components in a suitable powder blender, agglomerating the blended particles, compacting the agglomerated detergent particles to produce compacted sheets, and then granulating the compacted sheets to produce particles having a bulk density of from about 600 to about 1,050 grams/liter, a weighted average particle diameter of from about 1300 to about 2100 microns and a weighted average particle diameter to bulk density ration of form about 1.39 to about 2.60 (microns) (liter)/gram.

Agglomeration methods are well known to those skilled in the art. Agglomeration may be carried out in any apparatus suitable for the mixing of the dry particulate components and adopted so that liquid components may be sprayed on, or otherwise added to, a bed or falling curtain of one or more particulate components during the mixing operation. Any suitable mixing device such as an inclined pan agglomerator, a rotating drum or any other vessel with suitable means of agitation may be used. Methods of agitating, mixing and agglomerating particulate components are well-known to those skilled in the art. The apparatus may be designed or adapted for either continuous or batch operation.

Compacting may be performed by applying pressure to the blended unagglomerated raw materials. It may be performed by continuously admitting the blended raw materials to a zone wherein the materials are subjected to pressure between two rolls running oppositely with respect to each other. A preferred means of compacting is by a roller compactor, wherein the materials are subjected to pressure between two rolls under an adjustable compacting pressure. An especially preferred compactor is the Fitzpatrick Company “CHILSONATER” roll compactor. The gap between the rolls and the amount of raw materials introduced to such a roll compactor can be adjusted to produce cohesive detergent sheets or pellets of desired densities.

Granulating can be performed by any suitable granulating or crushing means. The resulting compacted sheets, pellets, or sticks may be crushed to a desired weighted average particle diameter range of about 1300 to about 2100 microns. Preferably, the compacted sheets, pellets, or sticks are fed through a sieve crusher to force the compacted materials through a sieve with meshes of a given size determining the particle size of the final product.

Screening, if desired, can be performed by any suitable screening device. For instance, the crushed material may be screened to separate oversized and undersized particles in conventional oscillating sieves. The oversized and undersized particles may be recycled into the process.

The above identified ingredients can be mixed with about 40 to about 60 weight percent water for form a liquid detergent.

The following examples and controls illustrate but do not limit the invention.

### Control Tests and Examples

The following Tests 1-7, demonstrate running tests in a controlled environment as well as the performance of a known detergent product presently on the market and Examples employing embodiments of the invention.

### Control 1

As a control, 45 pounds of typically soiled laundry from a hotel environment were washed in warm water (160° F.) without the benefit of using a detergent. At the end of the cycle, the washed linens were dried and evaluated for stains. Of 151 pieces added, 33 were found to be acceptably clean. This demonstrates that that although warm water was employed, without a detergent blend, the results were unacceptable. The reclaim rate was slightly greater than 78%. Such performance would not be viable in a commercial situation.

### Control 2

Further as a control and in like manner as described in Control 1, 45 pounds of typically soiled laundry were washed in cold water (44° F.) without the benefit of a detergent. Of the 155 pieces added, none was found to be acceptably cleaned. This is not surprising and shows a conformance to the Arrhenius principle wherein activity or rate is proportional by the square for every 10° C. The reclaim rate was therefore 100%.

### Control 3

As a further comparison, the laundry detergent made and sold by Ecolab, Inc., a division of Nalco Holding Company was used for evaluation. 4 ounces (112 grams) of the detergent were added to a 45 pound load. The wash and rinse cycles used cold water (44° F.). At the end of the washing and drying cycles, the original 148 items washed yielded 78 items that were acceptably cleaned. This is a reclaim rate of about 54%. This would be considered unacceptable. For comparison, the sample test was run using wash water at a temperature of 160° F. The 45 pound load consisted of 155 items. After the end of the washing and drying cycles, 144 items were considered to be acceptably cleaned. This result was significantly improved with a reclaim rate of about 7%. Although the final result was marginally in the range of acceptability, it required large quantities of hot water to achieve the desired results.

### Control 4

As a comparison of a commercial product, a sample of concentrated laundry detergent distributed by Gordon Food Service was similarly evaluated as described in Control 3. Using 4 ounces of detergent in cold water, 45 pounds or 140 items resulted in 70 acceptably cleaned items for a reclaim rate of 50%. In hot water 152 items were in like manner washed using 4 ounces at 160° F. 146 items were acceptably cleaned for a reclaim rate of 96%. This is considered a good result. Here again, considerable hot water had to be used to achieve acceptable results.

Examples 5 through 8 demonstrate results based upon the present invention.

### Example 5 and Comparison in Hot Water

TABLE

| INGREDIENT | % (w/w) |
|---|---|
| Water | 58.4 |
| caustic soda (50%) | 22.0 |
| soda ash | 6.0 |
| Sodium percarbonate | 5.0 |
| EDTA. tetrasodium salt | 2.0 |
| Alkaline amphoteric surfactant | 2.5 |
| Polyacrylic acid, sodium salt, neutralized | 1.4 |
| Polyethoxylated alcohol, HLB 11.5 (nonionic) | 1.1 |
| Sodium metasilicate | 1.1 |
| Alkyl naphthalene sulfonate, sodium salt (anionic) | 0.5 |

The amphoteric surfactant was a 35% solution of: beta-alanine, N-(2-carboxyethyl)-N-[3-octyloxy propyl]-sodium salt 1:1.

Four (4) ounces (128 grams) of the above composition was added to a commercial washing machine loaded with 45 pounds of soiled laundry and 60 gallons of water. Using water at 160° F., a full cycle (including 3 rinses) was performed. At the end, of 155 items added, only 1 was rejected as unacceptable. This is a reclaim rate of 99.4%. The same test was performed using 4 ounces except the water temperature was 45° F. At the end of the cycle, 150 soiled items were evaluated from which 142 were acceptable. The reclaim on the cold water run was about 94.6%. The hot water performed only slightly better than the cold water but the cold water wash consumed much less energy.

### Example 6

In like manner as described in Example 5, 4 ounces of the described composition were added to cold water (45° F.) wash cycle. In addition 3 fluid ounces of potassium hydroxide (45%) (122 grams) were added to increase the alkalinity. The pH was unchanged, but the conductivity (alkalinity) was increased. With a cold water wash (45° F.) using 148 soiled items. 146 were acceptable at the end of the cycle. The reclaim rate is about 98.6%. This example points out the utility of boosting the alkalinity to improve cleaning.

### Example 7

In like manner as described in Example 6, a cycle was run in cold water (45° F.) using 4 ounces of the detergent described in Example 5 plus 3 fluid ounces of 45% potassium hydroxide and 2.5 ounces (70 grams) of sodium dichloroisocyanurate were added, all at the same time. At the end of the entire wash and rinse cycles wherein 152 soiled fabric items were washed, all 152 items were determined to be acceptable. The reclaim rate was 100%. The test was repeated three additional times. Three of the four has a reclaim rate of 100%. In the fourth instance a reclaim rate of 99.6% was realized. This example points out the advantage of using an effective detergent composition in combination with increased alkalinity and a bleaching agent.

### Example 8

The fabrics washed as described in Example 7 were clean as reported. Due to the alkalinity of the washing solution, it was observed that the final rinse water had a pH that was variable but greater than 10. The residual alkaline materials made the fiber nap feel course and rough. So as to remove the residual alkalinity, 4 ounces (128 grains) of citric acid were added to the final rinse cycle. The pH of the rinse was 6.3 and the fabric appeared whiter and had a pronounced smoother feel.

The foregoing examples are understood to be illustrative of the invention and not fully comprehensive. One skilled in the art would readily recognize that alternatives are available to the described peroxy compounds, alkaline additives, bleaching agents, non-ionic, anionic and amphoteric additives and still remain within the intended scope of the claimed invention.

What is claimed is:

1. A particulate precursor laundry detergent composition which is substantially free of water and which is substantially completely soluble in alkaline cold water to form a cleaning solution said composition comprising:
(a) about 2 to about 20 weight percent of an inorganic hydroxide compound;
(b) about 1 to about 20 weight percent of metal carbonate;
(c) about 1 to about 20 weight percent of a peroxy compound;
(d) about 0.1 to about 7 weight percent of a chelating agent;
(e) about 0.1 to about 7 weight percent of a metasilicate, orthosilicate or mixture thereof;
(f) about 0.05 to about 7 weight percent of an acrylic polymer;
(g) about 0.1 to about 10 weight percent of an anionic surfactant;
(h) about 0.1 to about 12 weight percent of a nonionic surfactant; and
(i) about 0.1 to about 10 weight percent of an amphoteric surfactant.

2. The composition of claim 1 including about 0.1 to about 2.0 weight percent of a bleaching agent.

3. The composition of claim 1 wherein the inorganic hydroxide compound is selected from the group consisting of sodium hydroxide, potassium hydroxide, lithium hydroxide, ammonium hydroxide and mixtures thereof.

4. The composition of claim 1 including about 0.1 to about 2.0 weight percent of sodium dichloroisocyanurate.

5. The composition of claim 1 wherein the metal carbonate is selected from the group consisting of: sodium, lithium, potassium, rubidium, caesium carbonate and mixtures thereof.

6. The composition of claim 1 wherein the peroxy compound is selected from the group consisting of percarbonate, perborate, benzoylperoxide, peroxysulfate, hydrogen peroxide and mixtures thereof.

7. The composition of claim 1 wherein the chelating agent is selected from the group consisting of: ethylenediaminetetra acetic acid, ethylene diamine triacetic acid, hydroxethylenediamine triacetic acid, nitrilotriacetic acid, melamine, monodentate, bidentate, mono slats of the forgoing and mixtures thereof.

8. The composition of claim 1 wherein the metasilicate and orthosilicate is selected from the group consisting of sodium metasilicate, potassium metasilicate, sodium orthosilicate, lithium orthosilicate, potassium orthosilicate and mixtures thereof.

9. The composition of claim 1 wherein the acrylic polymer is selected from the group consisting of polyacrylic acid, polyacrylic polyvinyl acetate copolymer, poly acrylic acid polyvinyprrrolidone copolymer and mixtures thereof.

10. The composition of claim 1 wherein the anionic surfactant is selected from the group consisting of sodium xylene sulfonate, sodium toluene sulfonate, sodium cumene sulfonate, sodium t-butyl sulfonate, sodium diisopropynaphthalenel sulfonate, sodium dodecylbenzene sulfonate, 4,4′ bis (dodecylbenzene)ether, sodium salt, sodium lauryl sulfate, sodium laureth sulfate, and mixtures thereof.

11. The composition of claim 1 wherein the nonionic surfactant is selected from the group consisting of: alkylarylpolyoxyethylene ethanol, polyoxyethylene alcohols, polyoxyethylene/polyoxypropylene copolymers, and mixtures thereof.

12. The composition of claim 1 wherein the amphoteric surfactant is selected from the group consisting of: laurylaminopropylamine oxide, myristalaminopropylamine oxide, disodium lauryl iminodipropionate, imidazolines and imidazoline derivatives and mixtures thereof.

13. The composition of claim 1 including in addition a stability control additive for the peroxy compound.

14. The composition of claim 13 the stability control additive is selected from the group consisting of phosphonate salts, dialkyl anilines, carbazole sulfonates, diarylamine sulfonates and mixtures thereof.

15. The detergent of claim 1 comprising:
(a) about 5 to about 17 weight of an inorganic hydroxide compound;
(b) about 3 to about 15 weight percent of metal carbonate;
(c) about 3 to about 15 weight percent of a peroxy compound;
(d) about 0.6 to about 5 weight percent of a chelating agent;
(e) about 0.5 to about 5 weight percent of a metasilicate or orthosilicate or mixture thereof,
(f) about 0.1 to about 5 weight percent of an acrylic polymer;
(g) about 0.5 to about 7 weight percent of an anionic surfactant;
(h) about 0.3 to about 8 weight percent of a nonionic surfactant; and
(i) about 0.4 to about 8 weight percent of an amphoteric surfactant.

16. The composition of claim 15 including about 0.1 to about 2.0 weight percent of a dichloroisocyanurate.

17. A liquid precursor laundry detergent composition comprising the composition of claim 1 in solution with from about 40 to about 60 weight percent water.

18. The liquid precursor detergent composition of claim 17 comprising:
(a) about 5 to about 17 weight of an inorganic hydroxide compound;
(b) about 3 to about 15 weight percent of metal carbonate;
(c) about 3 to about 15 weight percent of a peroxy compound;
(d) about 0.6 to about 5 weight percent of a chelating agent;
(e) about 0.5 to about 5 weight percent of a metasilicate or orthosilicate or mixture thereof;
(f) about 0.1 to about 5 weight percent of an acrylic polymer;
(g) about 0.5 to about 7 weight percent of an anionic surfactant;
(h) about 0.3 to about 8 weight percent of a nonionic surfactant; and
(i) about 0.4 to about 8 weight percent of an amphoteric surfactant.

19. A method for laundering fabrics comprising: contacting the fabrics with wash water containing dissolved therein a sufficient quantity of the precursor laundry detergent of claim 1 to provide a cleaning environment for fabrics and a sufficient amount of a water soluble alkali to form a pH of greater than about 11 in said wash water and washing, rising and recovering said fabrics.

20. The method of claim 19 wherein the wash water is cold.

21. The method of claim 20 comprising:
(a) adding the fabrics to the wash water;
(b) adding the precursor detergent to the wash water in an amount of about 0.01 to about 1.0 oz. per gallon of wash water;
(c) adding a water soluble inorganic hydroxide to the wash water in an amount to adjust the pH of the wash water to greater than about 11;
(d) adding a dichloroisocyanurate to the wash water in an amount of from about 0.01 to about 0.5 oz. per gallon of wash water;
(e) running a wash cycle for a period of time sufficient to clean said fabrics;
(f) rinsing the fabrics following the wash cycle with a first cold water rinse cycle;
(g) removing the first rinse cycle water from the fabrics;
(h) adding cold water to the rinsed fabrics from step (g) for a second rinse cycle and adding a sufficient amount of an acid to form a pH in said second rinse water of less than about 7 and rinsing said fabrics, and
(i) recovering the fabrics from the second rinse cycle.

22. A method for laundering fabrics comprising contacting the fabrics with cold wash water dissolved therein the precursor detergent of claim 4 and a sufficient quantity of a water soluble inorganic hydroxide to provide a pH in said wash water of greater than about 11.
